(19) United States
(12) Patent Application Publication
(10) Pub. No.: US 2020/0372543 A1
(43) Pub. Date: Nov. 26, 2020

(54) ADVERTISEMENT SYSTEM, METHOD OF CONTROLLING ADVERTISEMENT SYSTEM, AND NON-TRANSITORY COMPUTER-READABLE STORAGE MEDIUM

(71) Applicant: SEIKO EPSON CORPORATION, Tokyo (JP)

(72) Inventors: Hideki KATO, MATSUMOTO-SHI (JP); Kan MATSUDA, SHIOJIRI-SHI (JP); Tomomi MIYASAKA, OKAYA-SHI (JP)

(21) Appl. No.: 16/880,122

(22) Filed: May 21, 2020

(30) Foreign Application Priority Data
May 24, 2019 (JP) 2019-097864

(51) Int. Cl. G06Q 30/02; G06F 3/12

(52) U.S. Cl. CPC G06Q 30/0269; G06F 3/1222; G06F 3/1287; G06F 3/1288; G06F 3/1238

(57) ABSTRACT

A posting server includes a server communication unit, and a server controller that transmits advertisement data and a plurality of pieces of ID information to the distribution member device. The distribution member device includes a wireless communication unit, and a device controller that selects one piece of the ID information from the plurality of pieces of ID information received, outputs the selected ID information and the received advertisement data to the printer, and causes the printer to generate an advertising material on which the selected ID information and advertisement data are printed. The pieces of ID information having different values are printed on the advertising material.

The present application is based on, and claims priority from JP Application Serial Number 2019-097864, filed May 24, 2019, the disclosure of which is hereby incorporated by reference herein in its entirety.

### BACKGROUND

### 1. Technical Field

The present disclosure relates to an advertisement system, a method of controlling an advertisement system, and a non-transitory computer-readable storage medium.

### 2. Related Art

In the related art, there has been known a system in which an advertising material having identification information embedded therein is distributed to determine an advertisement effect. For example, JP-A-2016-122271 disclose a marketing system in which paper media in which a paper medium ID is embedded are distributed, and the circumstances that led to the purchase of a product published on paper media are counted.

However, there is a demand for determining the advertisement effect on the distributed advertisement with higher accuracy.

### SUMMARY

According to an aspect of the present disclosure, an advertisement system includes a server apparatus, and a print control device that controls a printing apparatus, wherein the server apparatus includes a first communication unit, and a first controller that causes the first communication unit to transmit advertisement data and a plurality of pieces of identification information, wherein the print control device includes a second communication unit that receives the advertisement data and the plurality of pieces of identification information from the server apparatus, and a second controller that selects one piece of the identification information from the plurality of pieces of identification information received by the second communication unit, outputs the selected identification information and the advertisement data received by the second communication unit to the printing apparatus, and causes the printing apparatus to generate a printed matter on which the selected identification information and the advertisement data are printed.

In the above-mentioned advertisement system, the second controller may select the identification information that is different for each of a plurality of the printed matters.

In the above advertisement system, the first controller may cause the first communication unit to transmit a plurality of pieces of access information for accessing the server apparatus, the second controller may generate code information including the access information received by the second communication unit, output the generated code information and the advertisement data to the printing apparatus to cause the printing apparatus to print the printed matter, and each of the plurality pieces of access information may include the identification information.

In the above advertisement system, the server apparatus may include a storage unit that stores identification information of a distribution member who distributes the printed matter and an e-mail address of the distribution member in association with each other, and the first controller may acquire an e-mail address of a distribution member who uses the print control device to transmit, to the acquired e-mail address, area information specifying an area in which the printed matter is distributed.

In the above advertisement system, the print control device may include a position detection unit that detects a position of the print control device, a reading unit that reads the code information, and an operation unit that receives an operation, and the second controller may cause the position detection unit to detect a position of the print control device when an operation is received by the operation unit, and transmit, to the server apparatus, the identification information extracted from the code information read by the reading unit and position information indicating a position of the print control device.

In the above advertisement system, when the first controller receives an access request based on the access information, the first controller may acquire the identification information included in the access information from a request source device that made the access request, and after acquiring the identification information, transfer an access from the request source device to a web page on which at least one of a product and a service included in the advertisement data is described.

In the above advertisement system, the first controller may store the identification information and the position information received from the print control device in association with each other in a storage unit, and detect the position information associated with the identification information acquired from the request source device, identify an area in which a reaction level for the printed matter distributed based on the detected position information and the number of distribution sheets of the printed matter is equal to or more than a threshold value.

In the above advertisement system, the second controller may convert the selected identification information into code information, output the converted code information and the advertisement data to the printing apparatus, and cause the printing apparatus to generate a printed matter on which the selected identification information and the advertisement data are printed.

According to another aspect of the present disclosure, a method of controlling an advertisement system includes a server apparatus, and a print control device that controls a printing apparatus. The method includes, in the server apparatus, transmitting advertisement data and a plurality of pieces of identification information to the print control device. The method includes, in the print control device, receiving the advertisement data and the plurality of pieces of identification information from the server apparatus, selecting one piece of the identification information from the plurality of pieces of identification information received, and outputting the selected identification information and the advertisement data to the printing apparatus to cause the printing apparatus to generate a printed matter on which the selected identification information and the advertisement data are printed.

### BRIEF DESCRIPTION OF THE DRAWINGS

FIG. 1 is a system configuration diagram of an advertisement system.

FIG. 2 is a configuration diagram of a distribution member device.

FIG. 3 is a configuration diagram of a posting server.

FIG. 4 is a diagram schematically showing a configuration of a distribution member registration database.

FIG. 5 is a diagram schematically showing a configuration of a request information management database.

FIG. 6 is a diagram schematically showing a configuration of an access history database.

FIG. 7 is a sequence diagram showing an operation of the advertisement system.

FIG. 8 is a diagram showing an example of a report.

FIG. 9 is a flowchart showing the operation of the posting server.

FIG. 10 is a flowchart showing an operation of the posting server.

### DESCRIPTION OF EXEMPLARY EMBODIMENTS

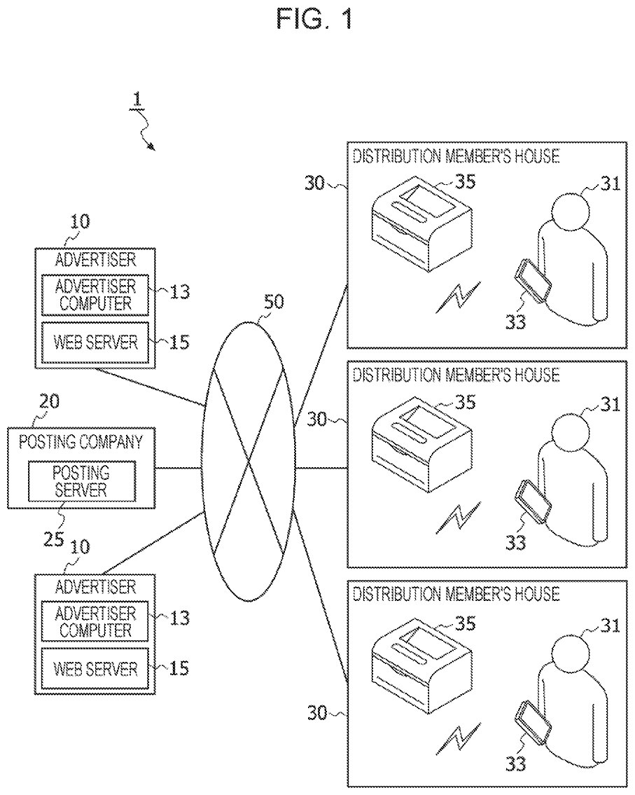

FIG. 1 is a system configuration diagram of an advertisement system 1. The advertisement system 1 is a system for posting an advertising material on which products and services provided by an advertiser 10 is printed. The advertisement system 1 includes an advertiser computer 13 and a web server 15 managed by the advertiser 10, a posting server 25 managed by a posting company 20, and a distribution member device 33 owned by a distribution member 31. The advertiser computer 13, the web server 15, the posting server 25, and the distribution member device 33 are configured to be connectable to a network 50. Although FIG. 1 illustrates the two advertiser computers 13 and the three distribution member devices 33, the number of the advertiser computers 13 and the number of the distribution member devices 33 are not limited. The posting server 25 corresponds to the “server apparatus” of the present disclosure. The distribution member device 33 corresponds to the “print control device” of the present disclosure.

The advertiser 10 is a provider of products and services, and uses the advertiser computer 13 and the like to generate advertisement data serving as a source of an advertising material in which an advertising material of products and services provided by the advertiser 10 is described. The advertisement data may be generated by the advertiser 10 operating the advertiser computer 13 or may be created by another company requested by the advertiser 10.

The advertiser computer 13 is a generally known computer device, and has a web browser installed. The web server 15 is a server computer that provides a web page. The web page contains details of products and services provided by the advertiser 10. The advertiser computer 13 and the web server 15 may be connected by a network such as an in-house local area network (LAN), for example. Further, the web server 15 may be a rental server provided by another company.

The advertiser 10 operates the advertiser computer 13 to activate the web browser installed on the advertiser computer 13 and access a web page provided by the posting server 25.

The advertiser computer 13 receives the web page of an authentication screen from the posting server 25, and displays the authentication screen for authenticating the user based on the received web page on a display. When the authentication screen is displayed on the display, the advertiser 10 inputs an advertiser ID and a password through a keyboard. The advertiser ID and the password are information for authenticating the user. For example, when the web page is first accessed, it is set by the advertiser 10, or it is set by the posting server 25.

When the authentication process is completed, the advertiser computer 13 receives the web page for specifying advertising distribution conditions and the like from the posting server 25 and displays the web page on the display. When the authentication process is completed and the web page is displayed on the display, the advertiser 10 inputs the distribution conditions of the advertisement to the displayed web page. The distribution conditions include a desired distribution area in which the advertising material is distributed, the desired number of distribution sheets, a desired distribution period, and the like. For example, a condition such as “distributing a total of 500 sheets of the advertising material with 100 sheets a day for 5 days on weekdays from date and month to data and month” is set.

In addition, the advertiser computer 13 receives the web page for uploading advertisement data from the posting server 25 and displays the web page on the display. The advertiser 10 operates a button displayed on the web page to select a directory of the advertiser computer 13 in which the advertisement data to be uploaded to the posting server 25 is stored. When the upload button displayed on the web page is pressed by the advertiser 10, request information including distribution conditions and advertisement data is uploaded to the posting server 25.

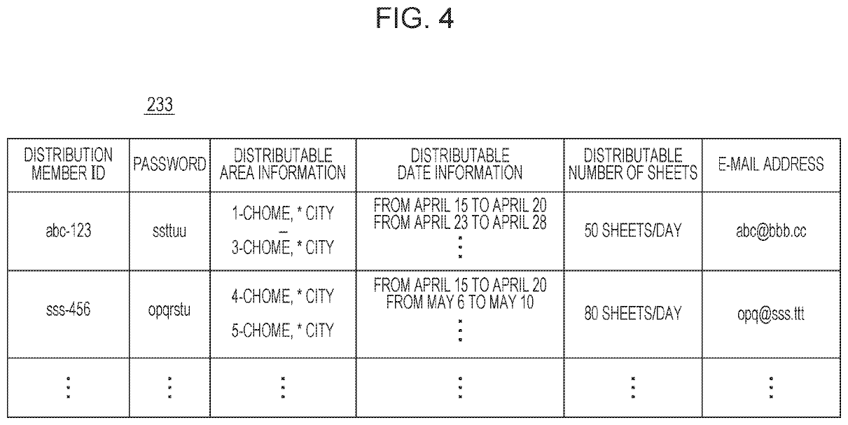

When the distribution conditions and the advertisement data are uploaded from the advertiser computer 13, the posting server 25 stores the uploaded distribution conditions and the advertisement data in a server storage unit 230 described later. The posting company 20 that manages the posting server 25 has contracted with a plurality of distribution members 31 who is in charge of distributing the advertisement. Distribution member registration information of the contracted distribution member 31 is registered in the posting server 25. Details of the distribution member registration information will be described with reference to FIG. 4. The posting server 25 selects the distribution member 31 to distribute the advertising material based on the distribution conditions and the distribution member registration information set by the distribution member 31. The posting server 25 causes a printer 35 of the selected distribution member to print the advertisement data via the distribution member device 33 and performs a process for requesting the selected distribution member to distribute the advertising material.

The distribution member 31 has the distribution member device 33. In addition, the printer 35 is installed in a distribution member's house 30, which is the home of the distribution member 31. The printer 35 corresponds to the “printing apparatus” of the present disclosure. The distribution member device 33 is, for example, a portable device such as a smartphone or a tablet computer. The distribution member device 33 can be connected to the network 50 by Wi-Fi, for example, and access the posting server 25. Wi-Fi is a registered trademark. In addition, the distribution member device 33 is connected to the printer 35. The connection between the distribution member device 33 and the printer 35 may be a wired connection such as a Universal Serial Bus (USB) or a wireless connection such as Wi-Fi. The distribution member device 33 may be owned by the distribution member 31, or may be lent by the posting company 20.

The printer 35 is, for example, a continuous ink supply system (CISS) type printing apparatus in which an ink tank that supplies ink to an ink jet head can be separately filled with the ink. In the present embodiment, the printer 35 is, for example, a stationary printing apparatus installed at the distribution member's house 30 that makes a predetermined contract with the posting company 20 and distributes the advertising material. The printer 35 may be owned by the distribution member 31 or lent by the posting company.

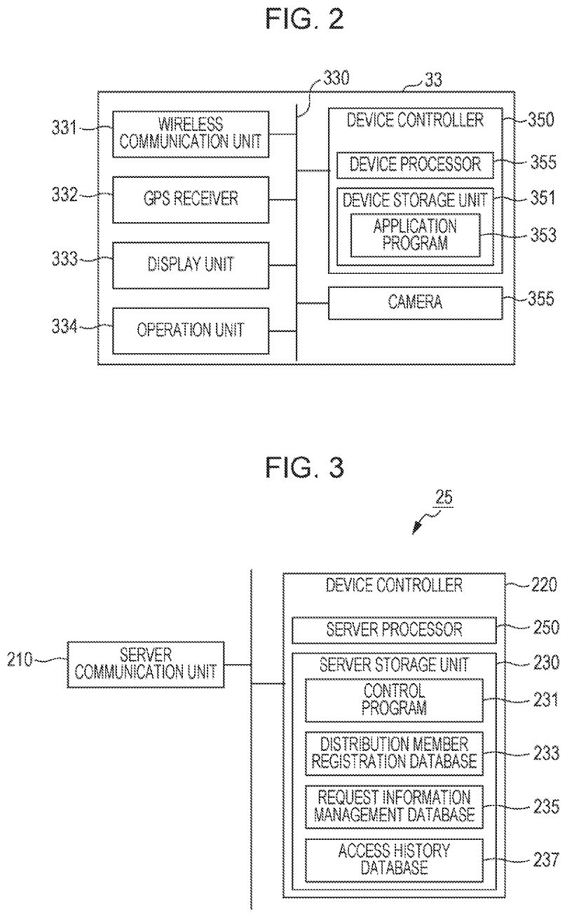

FIG. 2 is a configuration diagram of the distribution member device 33. The distribution member device 33 includes a wireless communication unit 331, a global positioning system (GPS) receiver 332, a display unit 333, an operation unit 334, a camera 335, and a device controller 350. The wireless communication unit 331 performs wireless communication according to a wireless communication standard such as a wireless LAN, and is connected to the network 50. The wireless communication unit 331 performs wireless communication according to a wireless communication standard such as a wireless LAN or Bluetooth, and is connected to the printer 35. The wireless communication unit 331 corresponds to an example of the “second communication unit” of the present disclosure. Bluetooth is a registered trademark.

A GPS receiver 332 receives a GPS signal transmitted from a GPS satellite. The GPS receiver 332 calculates the latitude and longitude indicating the position of the distribution member device 33 based on the received GPS signal. The GPS receiver 332 outputs the calculated latitude and longitude as position information to the device controller 350. The GPS receiver 332 corresponds to the “position detection unit” of the present disclosure.

The display unit 333 includes a display panel such as a liquid crystal panel or an organic EL panel. The operation unit 334 is configured by a touch panel provided on the display unit 333, and receives the user's touch operation.

The camera 335 is a so-called digital camera. The camera 335 includes an image sensor such as a charge coupled device (CCD) or a complementary metal oxide semiconductor (CMOS). Further, the camera 335 includes a data processing circuit that generates imaging data from a light receiving state of the image sensor. The camera 335 corresponds to the “reading unit” of the present disclosure.

The device controller 350 includes a device storage unit 351 and a device processor 355. The device controller 350 corresponds to the “second controller” of the present disclosure. The device storage unit 351 is configured by, for example, a nonvolatile memory such as a flash memory. The device storage unit 351 stores an application program 353 executed by the device processor 355. Hereinafter, the application program 353 is abbreviated as an application 353. The application 353 is, for example, a program provided by the posting company 20.

The device processor 355 is a processor such as a central processing unit (CPU) and a micro processing unit (MPU). When the device processor 355 executes the application 353, the device processor 355 can access the web page provided by the posting server 25, and download data from the posting server 25. In addition, when the device processor 355 executes the application 353, an application screen is displayed on a display unit 334. For example, a captured image by the camera 335 and buttons are displayed on the application screen. When the two-dimensional code captured by the camera 335 is displayed on the application screen, and the button is pressed by the distribution member 31, the device processor 355 decodes the two-dimensional code and extracts ID information described later. Further, the device processor 355 acquires the position information from the GPS receiver 332, and stores the acquired position information and the ID information in the device storage unit 351 in association with each other.

FIG. 3 is a configuration diagram of the posting server 25. The posting server 25 includes a server communication unit 210 and a server controller 220. The server communication unit 210 is connected to the network 50, and performs data communication with the advertiser computer 13, the web server 15, and the distribution member device 33 connected to the network 50. The server communication unit 210 corresponds to the “first communication unit” of the present disclosure, and the server controller 220 corresponds to the “first controller” of the present disclosure.

The server controller 220 includes the server storage unit 230 and a server processor 250. The server storage unit 230 includes a nonvolatile storage area that stores programs and data in a nonvolatile manner, and a volatile storage area that forms a work area for temporarily storing a program executed by the server processor 250 and data. FIG. 3 illustrates a case where the server controller 220 includes the server storage unit 230, but the server storage unit 230 may be provided outside the server controller 220.

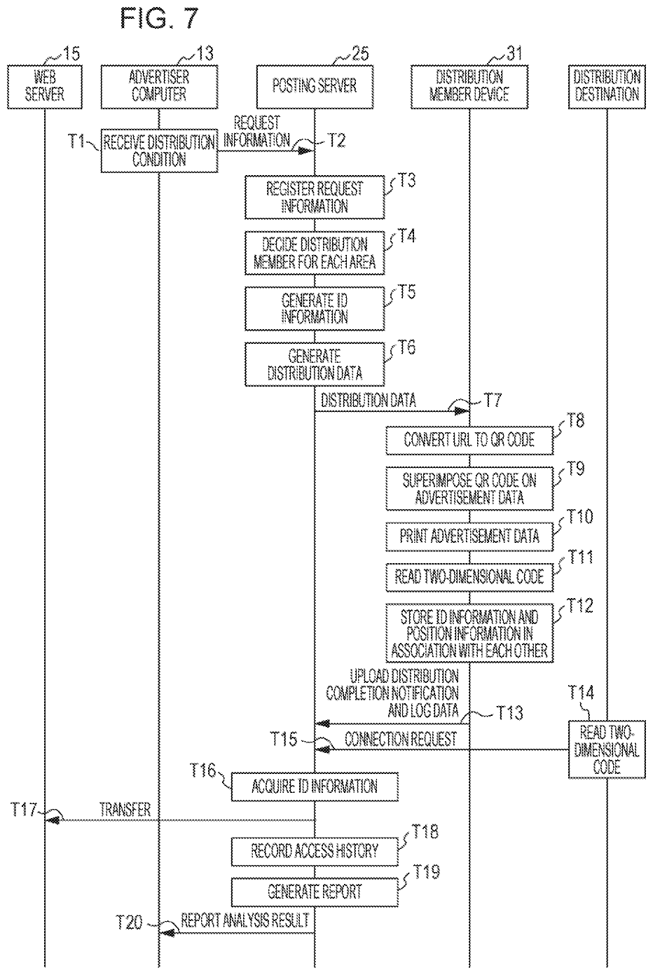

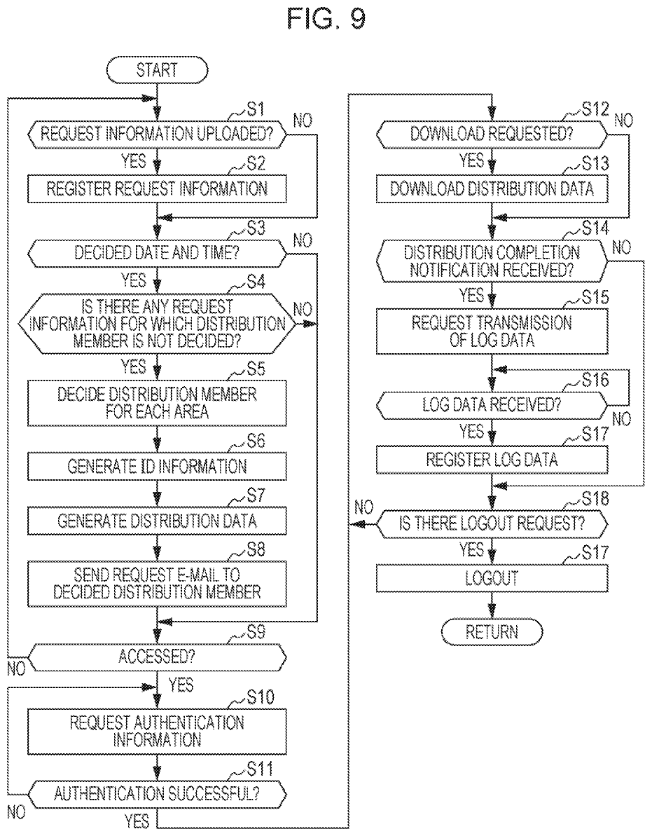

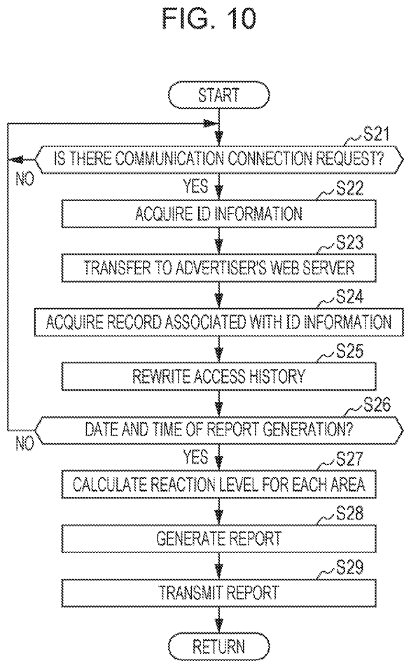

The server storage unit 230 stores a control program 231 executed by the server processor 250, a distribution member registration database 233, a request information management database 235, an access history database 237, and other various pieces of data. The server processor 250 executes the control program 231 to control respective units of the posting server 25. The details of the control operation executed by the server processor 250 will be described with reference to the sequence diagram illustrated in FIG. 7 and the flowcharts illustrated in FIGS. 9 and 10.

FIG. 4 is a diagram schematically illustrating the configuration of the distribution member registration database 233. In the distribution member registration database 233, distribution member registration information is registered in association with a distribution member ID. The distribution member registration information includes, for example, a password, distributable area information, distributable date information, the distributable number of sheets, an e-mail address, and the like. The distribution member ID corresponds to the “identification information of a distribution member” of the present disclosure. Further, the distribution member registration database 233 corresponds to the “storage unit” of the present disclosure.

The distribution member ID and the password are identification information for identifying the distribution member 31, and are uniquely set for each distribution member 31. The distribution member ID and the password are set by the posting server 25 or the distribution member 31 when the distribution member 31 is registered. The distribution member ID and the password are used, for example, when signing in to a web page provided by the posting server 25.

The distributable area information is information indicating an area where the distribution member 31 of the distribution member ID can distribute the advertising material, and is set based on the application information applied by the distribution member 31 when the distribution member 31 is registered. The distributable date information is information in which the distribution member 31 of the distribution member ID has registered a date on which the advertising material can be distributed. In addition to the distributable date information, a date when the advertising material cannot be distributed may be registered in the distribution member registration database 233. The distributable number of sheets is information indicating the number of sheets of the advertising material that can be distributed per unit period by the distribution member 31 of the distribution member ID. As the unit period, for example, a predetermined period such as one day, one week, or one month is set. The e-mail address is an e-mail address of the distribution member 31.

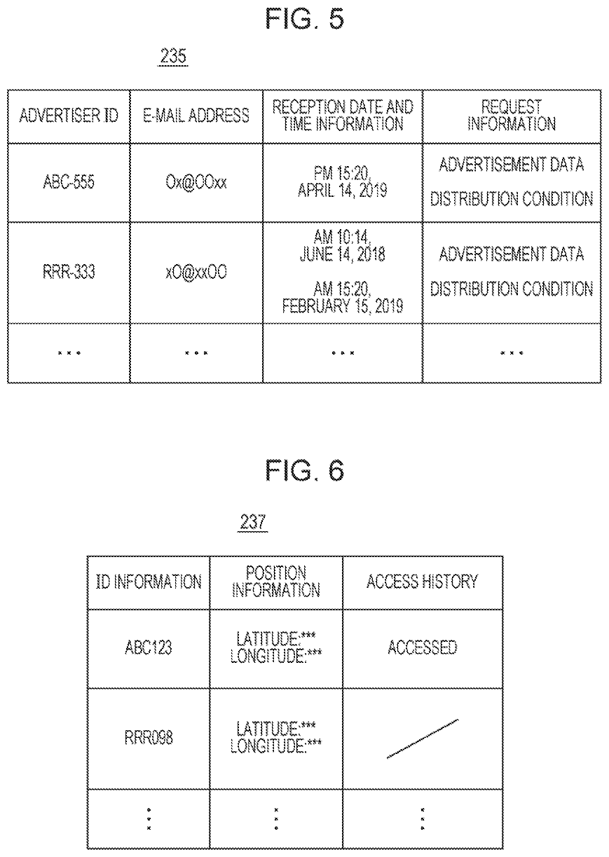

FIG. 5 is a diagram schematically showing the configuration of the request information management database 235. In the request information management database 235, an e-mail address, reception date and time information, and request information are registered in association with the advertiser ID. The advertiser ID is identification information for identifying the advertiser 10, and is set by the advertiser 10 or the posting server 25 when the advertiser 10 starts using the service provided by the posting company. The e-mail address is an e-mail address of the advertiser corresponding to the advertiser ID. The reception date and time information is information indicating the reception date and time when the request information was received from the advertiser computer 13. The request information includes the distribution conditions and the advertisement data described above.

FIG. 6 is a diagram schematically showing the configuration of the access history database 237. The access history database 237 corresponds to the “storage unit” of the present disclosure. In the access history database 237, position information and access history are registered in association with the ID information. The ID information is identification information attached to the advertising material distributed by the distribution member 31 and generated by the posting server 25. The ID information corresponds to the “identification information” of the present disclosure. The ID information may include, for example, information indicating the advertiser 10 and information indicating a distribution period during which the advertising material is distributed. Further, the ID information may include information for identifying the distribution member 31 who was in charge of distributing the advertising material. The number of pieces of the ID information generated is the same as the number of the desired number of distribution sheets set by the advertiser 10, and the generated pieces of the ID information has different values.

The position information is information that is uploaded by the distribution member device 33 together with the ID information, and is information indicating the position where the advertising material is distributed. Specifically, it is the position information detected by the GPS receiver 332 of the distribution member device 33 when the distribution member 31 distributes the advertising material.

In the access history, a history of whether a person who has viewed the distributed advertising material has accessed a web page provided by the advertiser 10 is recorded. When a person who has viewed the advertising material accesses a web page provided by the advertiser 10, a history of access is recorded.

FIG. 7 is a sequence diagram showing the operation of the advertisement system 1. The operation of the advertisement system 1 will be described with reference to the sequence diagram illustrated in FIG. 7. The advertiser computer 13 accesses the posting server 25 by the operation of the advertiser 10, and displays a web page provided by the posting server 25 on a display. The web page contains input fields such as advertisement distribution conditions. The distribution conditions include, for example, a desired distribution area, a desired number of distribution sheets, and a desired distribution period. The advertiser computer 13 receives the distribution condition by the operation of the advertiser 10 (step T1). When the upload button is pressed, the advertiser computer 13 uploads the distribution condition received in step T1 and the request information including the advertisement data to the posting server 25 (step T2). The posting server 25 registers the request information in the request information management database 235 in association with the advertiser ID (step T3).

When a preset time comes, the server controller 220 selects, for each distribution area, the distribution member 31 who is requested to distribute the advertising material based on the distribution condition uploaded from the advertiser computer 13 and the distribution member registration information (step T4). For example, the server controller 220 extracts, for each distribution area, the distribution member 31 who can distribute the advertising material to the desired distribution area set by the advertiser 10. For example, when the desired distribution areas are a distribution area A, a distribution area B, and a distribution area C, the server controller 220 extracts the distribution member 31 who can distribute the advertising material in each of the distribution area A, the distribution area B, and the distribution area C.

Next, the server controller 220 sets, based on the desired distribution period identified by the advertiser 10, a distribution period during which the advertising material is distributed. The distribution period can be set to any of, for example, one day, three days, one week, two weeks, one month, or the like. Next, the server controller 220 refers to the distributable date information of the extracted distribution member 31 and selects, for each of the distribution area A, the distribution area B, and the distribution area C, the distribution member 31 who can distribute the advertising material during the distribution period.

Further, the server controller 220 further selects the distribution member 31 based on the number of sheets of the advertisement material to be distributed during the distribution period and the number of distribution sheets which each distribution member 31 selected can distribute. For example, it is assumed that the desired distribution period set by the advertiser 10 is one month from April 1 to April 30, and the number of sheets distributed to the distribution area A is 400. It is also assumed that the method of distributing the advertising material is set to distribute 200 sheets of the advertising material every two weeks. The server controller 220 selects the distribution member 31 who can distribute 200 sheets of the advertising material. At this time, the selected distribution member 31 may be one person or a plurality of persons. That is, an advertising material may be distributed to one distribution area by one distribution member 31, or an advertising material may be distributed to one distribution area by a plurality of the distribution members 31.

Next, the server controller 220 generates ID information (step T5). The number of pieces of the ID information generated is the same as the number of the desired number of distribution sheets set by the advertiser 10, and the generated pieces of the ID information has different values.

Next, the server controller 220 generates distribution data for each distribution member 31 decided in step 14 (step T6). The distribution data includes advertisement data, a uniform resource locator (URL) list, distribution area information indicating a distribution area where the distribution member 31 distributes the advertising material, a distribution period, and the number of distribution sheets. In the URL list, the URLs having the same number as the number of sheets of the advertising material to be distributed by the distribution member 31 are registered. The URL includes the ID information generated in step T5. Therefore, all URLs registered in the URL list have different values. The URL corresponds to the “access information” of the present disclosure.

Next, the server controller 220 distributes the generated distribution data to each distribution member 31 decided in step 14. For example, the server controller 220 transmits a posting request e-mail to the e-mail addresses of all the decided distribution members 31.

The distribution member device 33 receives the e-mail by the operation of the distribution member 31, and displays the received e-mail on the display unit 333. Further, the distribution member device 33 activates the application 353 by the operation of the distribution member 31. The device controller 350 accesses the web page provided by the posting server 25 by activating the application 353. Upon receiving the access from the distribution member device 33, the posting server 25 transmits an authentication information acquisition request to the distribution member device 33. When receiving the authentication information from the distribution member device 33, the posting server 25 performs an authentication process using the authentication information, and when the authentication is successful, displays the web page on the distribution member device 33.

The web page contains a button for downloading distribution data to the distribution member device 33. When receiving the operation of the button displayed on the web page, the posting server 25 downloads the distribution data to the distribution member device 33 (step T7).

Next, the device controller 350 extracts the URL list and the advertisement data from the received distribution data. The device controller 350 selects one URL from the extracted URL list, and converts the selected URL into a two-dimensional code (step T8). The two-dimensional code may be, for example, a matrix-type code such as a QR code or a stack-type code such as PDF417. QR code is a registered trademark. Further, in the present embodiment, a case where the URL is converted into a two-dimensional code will be described, but the URL may be converted into a one-dimensional code. The two-dimensional code corresponds to the “code information” of the present disclosure.

The device controller 350 superimposes the converted two-dimensional code on the advertisement data (step T9). The advertisement data is provided with a superimposition position where the two-dimensional code is superimposed. This superimposition position is a position serving as a background of the advertising material, and does not include data relating to the advertisement. When requesting the advertiser 10 to create advertisement data, the posting company 20 notifies the advertiser 10 in advance of the range of the advertisement data on which the two-dimensional code is superimposed. The advertiser 10 creates the advertisement data so that the range notified by the posting company 20 does not include the data related to the advertisement.

The device controller 350 outputs the advertisement data on which the two-dimensional code is superimposed to the printer 35, and causes the printer 35 to print the advertising material (step T10). The device controller 350 executes the process of steps T8 to T10 for all URLs included in the URL list. As a result, the advertising material with the number of distribution sheets included in the distribution data is printed.

When the distribution member 31 prints the advertising material, the distribution member 31 moves to the distribution area indicated by the distribution area information while holding the printed advertising material and the distribution member device 33. When the distribution member 31 moves to the distribution area, the distribution member 31 operates the distribution member device 33 to activate the application 353 and starts distribution of the advertising material.

The distribution member device 33 activates the application 353 by the operation of the distribution member 31. Upon receiving the operation of the operation unit 334, the distribution member device 33 reads the two-dimensional code printed on the advertising material using the camera 335 (step T11). When the distribution member 31 moves near the post box of the house or apartment where the advertising material is distributed, the distribution member 31 operates the distribution member device 33 and causes the camera 335 to read the two-dimensional code before posting the advertising material to the post. After the two-dimensional code is read by the camera 335 of the distribution member device 33, the distribution member 31 posts the advertising material to the post box.

The device controller 350 decodes the two-dimensional code read by the camera 335 to extract ID information, and acquires position information from the GPS receiver 332. The device controller 350 stores the extracted ID information and the position information in association with each other in the device storage unit 351 as log data (step T12). While moving in the distribution area, the distribution member 31 move to the house or apartment as the distribution destination repeats an operation of operating the operation unit 334 to cause the distribution member device 33 to read the two-dimensional code and an operation of posting the advertising material to the post box to post all sheets of the advertising material.

When the distribution completion button on the application screen is pressed, the device controller 350 is connected to the posting server 25. When the distribution of all the advertising materials is completed, the distribution member 31 presses the distribution completion button displayed on the application screen. When connected to the posting server 25, the device controller 350 reads the log data from the device storage unit 351, and uploads the distribution completion notification and the log data to the posting server 25 (step T13).

A person who is interested in the advertising material by seeing the posted advertising material causes a camera in a device such as a smartphone that the person has to read the two-dimensional code printed on the advertising material. The device possessed by the person who saw the advertising material is hereinafter referred to as a customer device. Upon receiving the operation, the customer device reads the two-dimensional code printed on the advertising material (step T14). The customer device decodes the read two-dimensional code to extract the URL, and transmits a connection request to the extracted URL to the posting server 25 (step T15). The connection request corresponds to the “access request based on the access information”. Further, the customer device corresponds to the “request source device that made the access request” of the present disclosure. Upon receiving the connection request, the posting server 25 extracts the ID information included in the URL (step T16). Then, the posting server 25 transfers the received connection request to the preset web server 15 (step T17).

The posting server 25 searches the access history database 237 based on the ID information extracted from the URL, and detects a record in which the corresponding ID information is recorded. Then, the posting server 25 rewrites the access history of the corresponding record to “accessed” and records the access history (step T18).

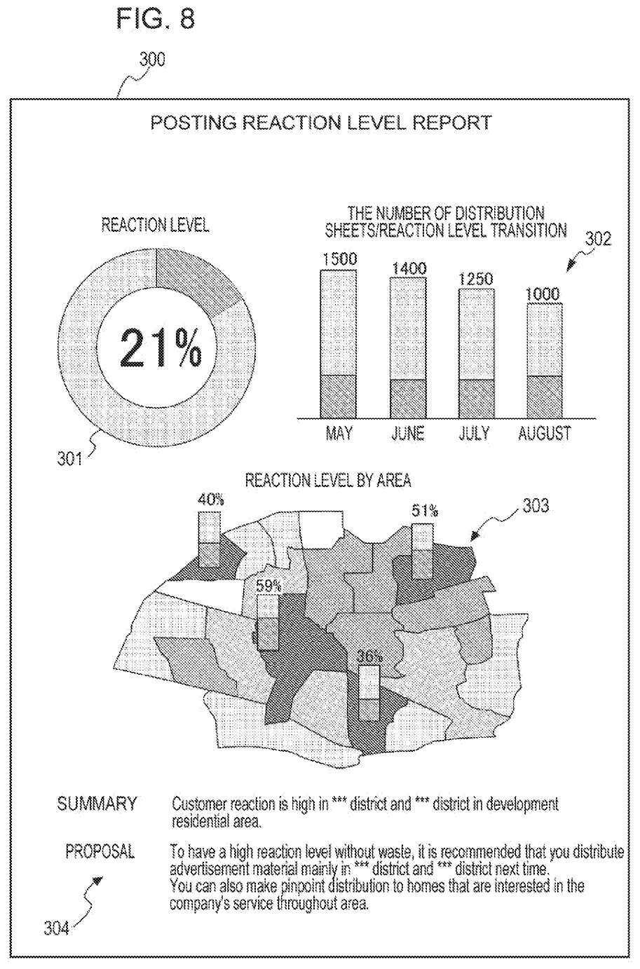

Also, for example, when a predetermined time has elapsed since the advertising material was distributed, the posting server 25 generates a report 300 on an advertisement effect for the distributed advertising material (step T18). FIG. 8 is a diagram illustrating an example of the report 300 generated by the posting server 25. The posting server 25 calculates the reaction level for each distribution area and the reaction level for the entire distribution area based on the access history registered in the access history database 237, the position information, the number of distribution sheets of the advertising material distributed by the distribution member 31, and the like. The reaction level for each distribution area is obtained by dividing the number of pieces of ID information from which the posting server 25 was accessed by the total number of distribution sheets of the advertising material distributed to the target distribution area. The reaction level for the entire distribution area is obtained by dividing the number of pieces of ID information from which the posting server 25 was accessed by the number of distribution sheets of the advertising material distributed to the entire distribution area.

After calculating the reaction level for each distribution area, the server controller 220 generates the report 300 based on the calculated reaction level (step T19). For example, a reaction level 301 for the entire distribution area to which the advertising material was distributed and a reaction level transition 302 for each month are described in this report 300. In addition, the report 300 indicates a map 303 of the entire distribution area, and in the map 303, each distribution area is illustrated in different colors according to the reaction level. For example, the server controller 220 may identify a distribution area in which the reaction level is equal to or greater than a threshold value, and display the identified distribution area in a different color from the colors of the other distribution areas on the map 303. In addition, the server controller 220 may display the reaction level for the distribution area in which the reaction level is equal to or more than the threshold value on the map 303 of the distribution area. Further, the report 300 describes, for example, a proposal of a distribution area in which it is better to distribute the advertising material at the next distribution of the advertising material. After generating the report 300, the posting server 25 transmits the generated report 300 to the advertiser computer 13 (step T20).

FIGS. 9 and 10 are flowcharts showing the operation of the posting server 25. The operation of the posting server 25 will be described with reference to the flowcharts of FIGS. 9 and 10. The server controller 220 determines whether the upload of the request information has been received (step S1). When the upload of the request information has not been received (step S1/NO), the server controller 220 advances the process to the determination in step S3.

When receiving the request information (step S1/YES), the server controller 220 registers the received request information in the request information management database 235 (step S2), and thereafter, the process proceeds to the determination in step S3.

Next, the server controller 220 determines whether the current date and time is the decided date and time when the distribution member 31 who distributes the advertising material is decided (step S3). For example, in a case of determining the distribution member 31 every day, a decided time of the day can be set as the decided date and time. In a case of determining the distribution member 31 once a week, a decided time on a decided day of the week can be set as the decided date and time. When the current date and time is not the decided date and time (step S3/NO), the server controller 220 advances the process to the determination of step S9.

When the current date and time is the date and time when the distribution member 31 is decided (step S3/YES), the server controller 220 determines whether the request information management database 235 contains request information for which the distribution member 31 is not decided (step S4). When there is no request information for which the distribution member 31 is not decided (step S4/NO), the server controller 220 advances the process to the determination of step S9.

Further, when there is request information for which the distribution member 31 is not decided (step S4/YES), the server controller 220 selects, for each area, the distribution member 31 who distributes the advertising material based on the request information and the distribution member registration information (step S5). For example, when the desired distribution area includes three distribution areas, which are the distribution area A, the distribution area B, and the distribution area C, the server controller 220 decides the distribution member 31 for each of the distribution area A, the distribution area B, and the distribution area C. For example, the server controller 220 decides a distribution period during which the distribution member 31 distributes the advertising material and the distribution area, and decides the distribution member 31 who can distribute the advertising material in the decided distribution area during the decided distribution period based on the distribution member registration information.

Next, the server controller 220 generates ID information (step S6). The server controller 220 generates the number of pieces of ID information same as the desired number of distribution sheets included in the request information. All pieces of ID information generated by the server controller 220 have different values. Next, the server controller 220 generates distribution data for each distribution member 31 decided in step S5 (step S7). The distribution data includes advertisement data, a URL list, distribution area information, a distribution period, and the number of distribution sheets. The URLs are registered in the URL list. The number of URLs registered in the URL list is the same as the number of distribution sheets. The URL includes the ID information generated in step S6.

Next, the server controller 220 reads the e-mail address of the distribution member 31 decided in step S5 from the distribution member registration database 233, and transmits, to the read e-mail address, a request e-mail requesting distribution of the advertising material (step S8). The distribution member 31 who sees the request e-mail operates the distribution member device 33 to activate the application 353 and accesses the web page of the posting server 25. Upon receiving the access from the distribution member device 33 (step S9/YES), the server controller 220 downloads the data of the authentication screen to the distribution member device 33 and requests acquisition of the authentication information (step S10). An authentication screen is displayed on the display unit 334 of the distribution member device 33. When the server controller 220 has not received access from the distribution member device 33 (step S9/NO), the process returns to the determination in step S1.

When the authentication screen is displayed on the display unit 334 of the distribution member device 33, the distribution member 31 operates the operation unit 334 to input the password and the distribution member ID. The device controller 350 of the distribution member device 33 uploads the received password and the received distribution member ID to the posting server 25. The server controller 220 performs an authentication process based on the authentication information uploaded from the distribution member device 33. When the authentication has failed (step S11/NO), the server controller 220 returns the process to step S10 and requests re-input of the authentication information.

When the authentication is successful (step S11/YES), the server controller 220 causes the display unit 334 of the distribution member device 33 to display the web page. The web page contains a download button, a logout button, a distribution completion button, and the like. When the download button is pressed by the distribution member 31, the server controller 220 receives a request for downloading distribution data (step S12). The server controller 220 downloads the distribution data to be distributed by the logged-in distribution member 31 to the distribution member device 33 (step S13).

When the download request has not been received (step S12/NO), the server controller 220 determines whether a distribution completion notification indicating that the distribution of the advertising material has been completed has been received (step S14). When the distribution completion button displayed on the web page is pressed by the distribution member 31, the distribution completion notification is uploaded to the posting server 25. When receiving the distribution completion notification (step S14/YES), the server controller 220 transmits a log data transmission request to the distribution member device 33 (step S15). The device controller 350 of the distribution member device 33 uploads the log data stored in the device storage unit 351 to the posting server 25.

Upon transmitting the log data transmission request to the distribution member device 33, the server controller 220 determines whether log data has been received from the distribution member device 33. When log data has not been received from the distribution member device 33 (step S16/NO), the server controller 220 waits until the log data is received. Further, when receiving the log data from the distribution member device 33 (step S16/YES), the server controller 220 registers the received log data in the access history database 237 (step S17).

When determining in step S14 that the distribution completion notification has not been received (step S14/NO), the server controller 220 determines whether a logout operation has been received (step S18). When the logout button displayed on the web page is pressed by the distribution member 31, the posting server 25 receives the logout operation. When receiving the logout operation (step S18/YES), the server controller 220 performs the logout process (step S19). When the logout operation has not been received (step S18/NO), the server controller 220 returns the process to the determination in step S12.

FIG. 10 is a flowchart showing the operation of the posting server 25 when an access is received from a device possessed by a person who has viewed the advertising material. A person who is interested in the advertising material by seeing the posted advertising material causes a camera in a customer device such as a smartphone to read the two-dimensional code printed on the advertising material. The customer device decodes the read two-dimensional code to extract the URL, and accesses the posting server 25 based on the extracted URL. That is, the customer device requests a communication connection from the posting server 25, and upon completion of the communication connection, transmits a transmission request for the file indicated by the character string included in the URL to the posting server 25. The character string includes ID information.

The server controller 220 determines whether there is a communication connection request from the customer device (step S21). When there is no communication connection request (step S21/NO), the server controller 220 waits until the communication connection request is received (step S21).

When the server controller 220 receives the request for communication connection (step S21/YES), the server controller 220 performs communication connection with the customer device. When the communication connection is completed, the server controller 220 receives a character string specifying a file from the customer device. The server controller 220 extracts ID information from the character string (step S22). After extracting the ID information, the server controller 220 transfers the access from the customer device to the web server 15 provided by the advertiser 10 (step S23). A web page provided by the web server 15 is displayed on the customer device. The web page contains information on products and services provided by the advertiser 10.

Further, the server controller 220 refers to the access history database 237 and detects a record associated with the ID information acquired from the customer device (step S24). The server controller 220 rewrites the access history of the detected record to “accessed” (step S25).

Next, the server controller 220 determines whether it is the date and time of generating the report 300 in which the reaction to the advertisement is reported to the advertiser 10 (step S26). When it is not the date and time of generating the report 300 (step S26/NO), the server controller 220 returns the process to the determination in step S21.

When it is the date and time of generating the report 300 (step S26/YES), the server controller 220 calculates the reaction level for each distribution area based on the access history and the position information registered in the access history database 237 (step S27). After calculating the reaction level for each distribution area, the server controller 220 generates the report 300 based on the calculated reaction level (step S28). The report 300 describes, for example, a reaction level for each distribution area, and a proposal of a distribution area in which it is better to distribute the advertising material at the next distribution of the advertising material. The server controller 220 transmits the generated report to the advertiser computer 13 (step S29).

As described above, the advertisement system 1 according to the present embodiment includes the posting server 25 and the distribution member device 33 that controls the printer 35. The posting server 25 includes the server communication unit 210 and the server controller 220. The server controller 220 downloads the advertisement data and the plurality of pieces of ID information to the distribution member device 33 through the server communication unit 210.

The distribution member device 33 includes the wireless communication unit 331 and the device controller 350. The wireless communication unit 331 receives the advertisement data and the plurality of IDs from the posting server 25. The device controller 350 selects one piece of ID information from the plurality of pieces of ID information, outputs the selected ID information and the advertisement data to the printer 35, and generates an advertising material on which the selected ID information and the advertisement data are printed. Therefore, when the advertising material is distributed, it is possible to identify the distributed advertising material. For example, when distributing an advertising material, the ID information and the distribution position are registered in association with each other. When a person who saw the advertising material came to the store, the ID information from the advertising material brought by the person who saw the advertising material is identified, so that it is possible to identify the distribution area having a high reaction level to the advertising material. Also, by using information associated with the distribution period of the advertising material as the ID information, it is also possible to identify which period the advertising material which is distributed at has a higher reaction level. Furthermore, by associating the ID information with the identification information of the distribution member 31 who distributes the advertising material, it is possible to determine which distribution member 31 the advertising material which is distributed by has a higher reaction level. Therefore, it is possible to determine the advertisement effect on the distributed advertisement material with higher accuracy.

Further, the device controller 350 selects different pieces of ID information for each of the printed matters. Therefore, the pieces of ID information having different values are printed on the sheets of the advertising material created by the printer 35. Therefore, it is possible to distinguish the sheets of the advertising material generated by the printer 35.

Further, the server controller 220 transmits a plurality of URLs for accessing the posting server 25 to the distribution member device 33 through the server communication unit 210. The device controller 350 generates the two-dimensional code including the access information, outputs the generated two-dimensional code and the advertisement data to the printer 35, and causes the printer 35 to print the advertising material. The plurality of URLs includes the pieces of ID information having different values. Therefore, it is possible to cause the printer 35 to print the advertising material in which the URL including the ID information is two-dimensionally coded. A person who has viewed the advertising material can access the posting server 25 by reading the two-dimensional code using the device possessed by the person. Since the URL includes ID information having different values, the posting server 25 can identify, through the URL, from which advertising material the access was made by reading the two-dimensional code printed on the advertising material.

The posting server 25 includes the distribution member registration database 233 storing the distribution member ID of the distribution member 31 who distributes the printed matter and the e-mail address of the distribution member 31 in association with each other. The server controller 220 acquires the e-mail address of the distribution member 31 using the distribution member device 33, and transmits, to the acquired e-mail address, area information specifying an area in which the printed matter is distributed. Therefore, the posting server 25 can identify an area in which the advertising material is distributed by the distribution member 31.

The distribution member device 33 includes the GPS receiver 332 that detects a position, the camera 335 that reads a two-dimensional code, and the operation unit 334 that receives an operation. When the operation is received by the operation unit 334, the device controller 350 causes the GPS receiver 332 to detect the position information of the distribution member device 33. Further, the device controller 350 transmits, to the posting server 25, ID information extracted from the two-dimensional code read by the camera 335 and position information indicating the position of the distribution member device 33. Therefore, when the distribution member 31 operates the operation unit 334 in distributing the advertising material, the posting server 25 can acquire the position where the advertising material is distributed and the ID information attached to the advertising material distributed at this position. Therefore, it is possible to identify the position where the advertising material is distributed.

When receiving the access request based on the URL, the server controller 220 acquires the ID information included in the URL, after acquiring the URL, the access from the request source device that made the access request is transferred to a web page on which at least one of a product and a service included in the advertisement data is described. Therefore, when the two-dimensional code attached to the advertising material is read, and the posting server 25 is accessed, it is possible to identify from which advertising material the access was made by reading the two-dimensional code printed on the advertising material. In addition, a person who has viewed the advertising material can access a web page on which at least one of a product and a service of the advertising material is described by reading the two-dimensional code with a device owned by the person.

The server controller 220 stores, in the access history database 237, the ID information and the position information received from the distribution member device 33 in association with each other. Further, the server controller 220 detects the position information associated with the ID information acquired from the request source device that made the access request. Further, the server controller 220 identifies a distribution area where the reaction level for the distributed advertising material is equal to or larger than a threshold value based on the detected position information and the number of distribution sheets of the advertising material. Therefore, it is possible to identify a distribution area having a high reaction level for the advertising material. By distributing the advertising material again to the distribution area having the high reaction level, it is possible to reduce the risk that an effect corresponding to the advertising cost may not be obtained.

### Modification

As a modification of the above-described embodiment, the customer who has actually visited the store of the advertiser 10 after viewing the advertising material may be identified to obtain the reaction level. For example, the advertiser 10 generates advertisement data including coupon data, and uploads the generated advertisement data to the posting server 25. The posting server 25 generates the pieces of ID information corresponding to the number of distribution sheets of the advertising material, and transmits the advertisement data and the ID information to the distribution member device 33.

The device processor 355 executing the application 353 converts the ID information into a two-dimensional code, embeds the converted two-dimensional code in the coupon data, and outputs the advertisement data in which the two-dimensional code is embedded to the printer 35 to causes the printer 35 to print the advertising material.

The distribution member 31 distributes the advertising material printed by the printer 35 to the distribution area designated by the posting server 25. At this time, as in the above-described embodiment, the distribution member 31 activates the application 353 of the distribution member device 33 and causes the camera 335 to read the coupon of the advertising material before posting the advertising material to the distribution destination. When the camera 335 reads the coupon, the device processor 355 executing the application 353 extracts the ID information from the read coupon. Further, the device processor 355 acquires the position information from the GPS receiver 332, and stores the ID information and the position information in the device storage unit 351 in association with each other. Further, when the distribution of the advertising material is completed, the device processor 355 uploads the log information in which the ID information is associated with the position information to the posting server 25.

A user who is interested in products and services described in the advertising material goes to the store of the advertiser 10 with the advertising material or a coupon cut out from the advertising material. At the store of the advertiser 10, the clerk causes a store terminal prepared in the store to read the coupon brought by the user. In addition, the clerk operates the store terminal, extracts the ID information from the read coupon, and stores the extracted ID information in the storage unit of the store terminal. In addition, the clerk logs in to the posting server 25 by the advertiser ID, the password or the like that identifies the advertiser 10 for each set period such as one day or one week, and uploads the ID information read by the store terminal to the posting server 25.

When the ID information is uploaded from the store terminal, the posting server 25 refers to the access history database 237 and detects a record of the uploaded ID information. The posting server 25 rewrites the access history of the detected record to “accessed”.

As described above, in the modification, when a person who has viewed the advertising material comes to the store, the ID information is identified from the advertising material brought by the person who has viewed the advertising material, so that a distribution area having a high reaction level to the advertising material can be identified.

The embodiment described above is merely an aspect of the present disclosure, and any modification and application can be made within the scope of the present disclosure.

Further, when the method of controlling the advertisement system is implemented by a computer provided in the posting server 25 and a computer of the distribution member device 33, the program to be executed by the computers may be configured in a form of a recording medium or a transmission medium for transmitting the program. As the recording medium, a magnetic or optical recording medium or a semiconductor memory device can be used. Specifically, examples of the recording medium include a portable type or fixed type recording medium such as a flexible disk, an hard disk drive (HDD), a compact disk read only memory (CD-ROM), a digital versatile disk (DVD), a Blu-ray disc, a magneto-optical disk, a flash memory, or a card type recording medium. Further, the recording medium may be a nonvolatile storage device such as a random access memory (RAM), a read only memory (ROM), a HDD, or the like which is an internal storage device included in the server apparatus. Blu-ray is a registered trademark.

In addition, the processing stage of the flowchart in FIGS. 9 and 10 is divided in accordance with the main processing contents in order to make the processing of the server controller 220 easier to understand. The way the processing stages are separated and the names of the processing stages in the flowcharts of FIGS. 9 and 10 do not limit the present disclosure. In addition, the processing by the server controller 220 can be divided into more processing stages depending on the processing contents, or can be divided such that one processing stage includes more processing. Further, the order of processing in the flowcharts is not limited to the illustrated example.

What is claimed is:

1. An advertisement system comprising: a server apparatus; and a print control device that controls a printing apparatus, wherein
the server apparatus includes
a first communication unit, and
a first controller that causes the first communication unit to transmit advertisement data and a plurality of pieces of identification information, wherein
the print control device includes
a second communication unit that receives the advertisement data and the plurality of pieces of identification information from the server apparatus, and
a second controller that selects one piece of the identification information from the plurality of pieces of identification information received by the second communication unit, outputs the selected identification information and the advertisement data received by the second communication unit to the printing apparatus, and causes the printing apparatus to generate a printed matter on which the selected identification information and the advertisement data are printed.

2. The advertisement system according to claim 1, wherein the second controller selects the identification information that is different for each of a plurality of the printed matters.

3. The advertisement system according to claim 1, wherein
the first controller causes the first communication unit to transmit a plurality of pieces of access information for accessing the server apparatus, wherein
the second controller generates code information including the access information received by the second communication unit, outputs the generated code information and the advertisement data to the printing apparatus to cause the printing apparatus to print the printed matter, and wherein
each of the plurality pieces of access information includes the identification information.

4. The advertisement system according to claim 3, wherein
the server apparatus includes a storage unit that stores identification information of a distribution member who distributes the printed matter and an e-mail address of the distribution member in association with each other, and wherein
the first controller acquires an e-mail address of a distribution member who uses the print control device to transmit, to the acquired e-mail address, area information specifying an area in which the printed matter is distributed.

5. The advertisement system according to claim 3, wherein
the print control device includes
a position detection unit that detects a position of the print control device,
a reading unit that reads the code information, and
an operation unit that receives an operation, wherein
the second controller causes the position detection unit to detect a position of the print control device when an operation is received by the operation unit, and transmits, to the server apparatus, the identification information extracted from the code information read by the reading unit and position information indicating a position of the print control device.

6. The advertisement system according to claim 5, wherein when the first controller receives an access request based on the access information, the first controller acquires the identification information included in the access information from a request source device that made the access request, and after acquiring the identification information, transfers an access from the request source device to a web page on which at least one of a product and a service included in the advertisement data is described.

7. The advertisement system according to claim 6, wherein
the first controller stores the identification information and the position information received from the print control device in association with each other in a storage unit, and
detects the position information associated with the identification information acquired from the request source device to identify an area in which a reaction level for the printed matter distributed based on the detected position information and the number of distribution sheets of the printed matter is equal to or more than a threshold value.

8. The advertisement system according to claim 1, wherein the second controller converts the selected identification information into code information, outputs the converted code information and the advertisement data to the printing apparatus, and causes the printing apparatus to generate a printed matter on which the selected identification information and the advertisement data are printed.

9. A method of controlling an advertisement system including a server apparatus, and a print control device that controls a printing apparatus, the method comprising:
in the server apparatus,
transmitting advertisement data and a plurality of pieces of identification information to the print control device;
in the print control device,
receiving the advertisement data and the plurality of pieces of identification information from the server apparatus;
selecting one piece of the identification information from the plurality of pieces of identification information received; and
outputting the selected identification information and the advertisement data to the printing apparatus to cause the printing apparatus to generate a printed matter on which the selected identification information and the advertisement data are printed.

10. A non-transitory computer-readable storage medium storing a program for controlling a printing apparatus,
the program causing
a computer of a print control device to execute a method, the method comprising:
receiving advertisement data and a plurality of pieces of identification information from a server apparatus;
selecting one piece of the identification information from the plurality of pieces of identification information received; and
outputting the selected identification information and the received advertisement data to the printing apparatus to cause the printing apparatus to generate a printed matter on which the selected identification information and the advertisement data are printed.
